(19) United States
(12) Patent Application Publication
(10) Pub. No.: US 2014/0075200 A1
(43) Pub. Date: Mar. 13, 2014

(54) METHOD FOR MANAGING ELECTRONIC FILE AND ELECTRONIC FILE MANAGEMENT APPARATUS

(71) Applicants: Toshiba Tec Kabushiki Kaisha, Tokyo (JP); KABUSHIKI KAISHA TOSHIBA, Tokyo (JP)

(72) Inventor: Shigeo UCHIDA, Shizuoka (JP)

(73) Assignees: TOSHIBA TEC KABUSHIKI KAISHA, Tokyo (JP); KABUSHIKI KAISHA TOSHIBA, Tokyo (JP)

(21) Appl. No.: 14/012,169

(22) Filed: Aug. 28, 2013

(30) Foreign Application Priority Data
Sep. 7, 2012 (JP) 2012-197351

(51) Int. Cl. H04L 9/32

(52) U.S. Cl. CPC H04L 9/3281
USPC 713/176

(57) ABSTRACT

In accordance with one embodiment, a method for managing an electronic file include creating an electronic signature of a user who is generating an electronic file by encrypting the electronic file using a private key of the user, and embedding the created electronic signature of the user and a public key certificate of the user, in the electronic file. The public key certificate of the user certifying a public key of the user corresponding to the private key of the user and including a link to a certificate list that shows whether or not the public key certificate of the user is valid.

### CROSS-REFERENCE TO RELATED APPLICATION

This application is based upon and claims the benefit of priority from Japanese Patent Application No. 2012-197351, filed Sep. 7, 2012, the entire contents of which are incorporated herein by reference.

### FIELD

Embodiments described herein relate to a method for managing an electronic file, and an electronic file management apparatus.

### BACKGROUND

Conventionally, it is known that an electronic signature and a time stamp are attached to an electronic file to guarantee the originality of an electronic file after a corresponding paper document is scanned and computerized. Using the electronic signature, confirmation of the person who created the electronic file and detection of falsification of the electronic file can be carried out. In addition, using a time stamp, it can be certified that the electronic file existed at the time indicated by the time stamp.

However, in the manner described above, if a public key certificate of a signer of the electronic signature expires or a public key certificate of a time stamp certificate authority issuing the time stamp expires, the originality of the electronic file cannot be guaranteed. In order to deal with this drawback, a scheme of a long term guarantee by verifying the correctness of the electronic file and acquiring a time stamp before the expiration date is proposed.

For example, by combining a component of PAdES Basic and a component of PAdES LTV, the long term guarantee of a PDF file can be achieved. In addition, in the PAdES Basic, embedding information for verifying the public key certificate of the electronic signature in the PDF file is determined as a standard.

When a revocation list (CRL) of the public key certificate of the electronic signature is embedded in the PDF file as the verification information, there is a problem that the total size of the PDF file in which the verification information is embedded becomes quite large no matter what the size of the original PDF file is. This is because the file size of the CRL may be several hundred kilobytes.

### BRIEF DESCRIPTION OF THE DRAWINGS

FIG. 1 illustrates a configuration of an electronic file management system including an electronic file management apparatus according to one embodiment.

FIG. 2 is a block diagram illustrating a configuration of a document management apparatus according to the embodiment.

FIG. 3 illustrates an example of a hierarchical structure of a certificate authority shown in FIG. 1.

FIG. 4 is a flowchart illustrating a processing executed in the document management apparatus according to the embodiment.

FIG. 5 is a flowchart illustrating a verification processing of a public key certificate in the embodiment;

FIG. 6 is a flowchart illustrating a creating processing of verification information in the embodiment.

FIG. 7 is a flowchart illustrating the verification processing of an electronic signature and a time stamp in the embodiment.

FIG. 8 is a flowchart illustrating the verification processing when a CRL is stored in the document management apparatus according to a second embodiment.

### DETAILED DESCRIPTION

In accordance with one embodiment, a method for managing an electronic file include creating an electronic signature of a user who is generating an electronic file by encrypting the electronic file using a private key of the user, and embedding the created electronic signature of the user and a public key certificate of the user, in the electronic file. The public key certificate of the user certifying a public key of the user corresponding to the private key of the user and including a link to a certificate list that shows whether or not the public key certificate of the user is valid.

Hereinafter, embodiments are described with reference to accompanying drawings. In addition, a same section is marked with a same symbol in each figure. (First embodiment)

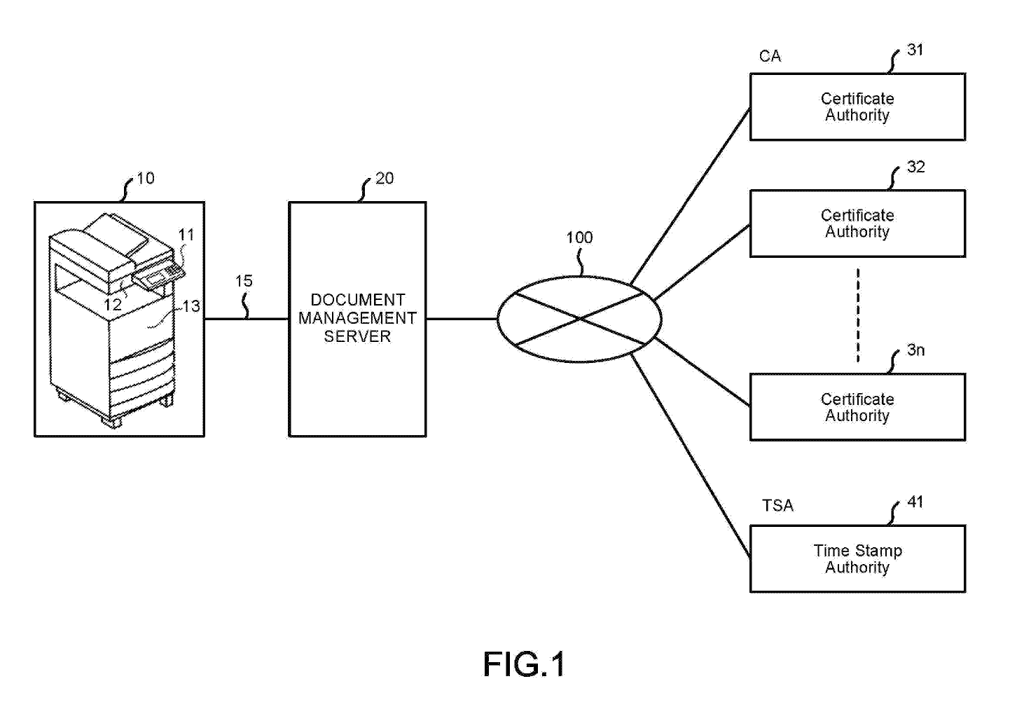

FIG. 1 illustrates a configuration of an electronic file management system according to a first embodiment. In FIG. 1, the electronic file management system includes an image forming apparatus 10 including a scanner; a document management server 20 storing a document; a plurality of certificate authorities (CA: Certificate Authority) 31, 32 . . . 3n, a time stamp authority (TSA: Time Stamp Authority) 41; and a network connecting all the sections described above. The network is an internet 100 when connecting among the document management server 20, the certificate authorities (CA) 31, 32...3n, and the time stamp authority 41, and the network is an internet or an LAN (Local Area Network) 15 and the like when connecting between the image forming apparatus 10 and the document management server 20.

The image forming apparatus 10, for example, is a MFP (Multi-Function Peripheral). An operation section 11 is arranged at an upper portion of a main body of the MFP 10. The operation section 11 includes various keys (for example, a numerical key, a clear key, a start key, and the like), and a touch panel type display section such as a liquid crystal displayer and the like. In addition, an original table is arranged at the upper portion of the MFP 10, and an auto document feeder is arranged on the original table. In addition, the MFP 10 comprises a scanner 12 and a printer section 13. The scanner 12 reads an original placed on the original table or an original fed by the auto document feeder. An operator can scan the document using the scanner 12, and send an image acquired by the scanning to the document management server 20.

The document management server 20 acquires image data corresponding to the image scanned by the scanner 12. Moreover, the document management server 20 has a function of determining whether or not the acquired image data is in a form of a PDF (Portable Document Format) file and converting it into the PDF file if the acquired image data is not in a form of a PDF file. In addition, the document management server 20 communicates with the certificate authorities 31, 32 . . . 3n and the time stamp authority 41 through the network 100.

Each of the certificate authorities 31, 32 . . . 3n issues one or more public key certificates to be used in the electronic signature, and moreover, discloses revocation information needed for the verification of the public key certificate. In addition, the time stamp authority 41 provides a time stamp service.

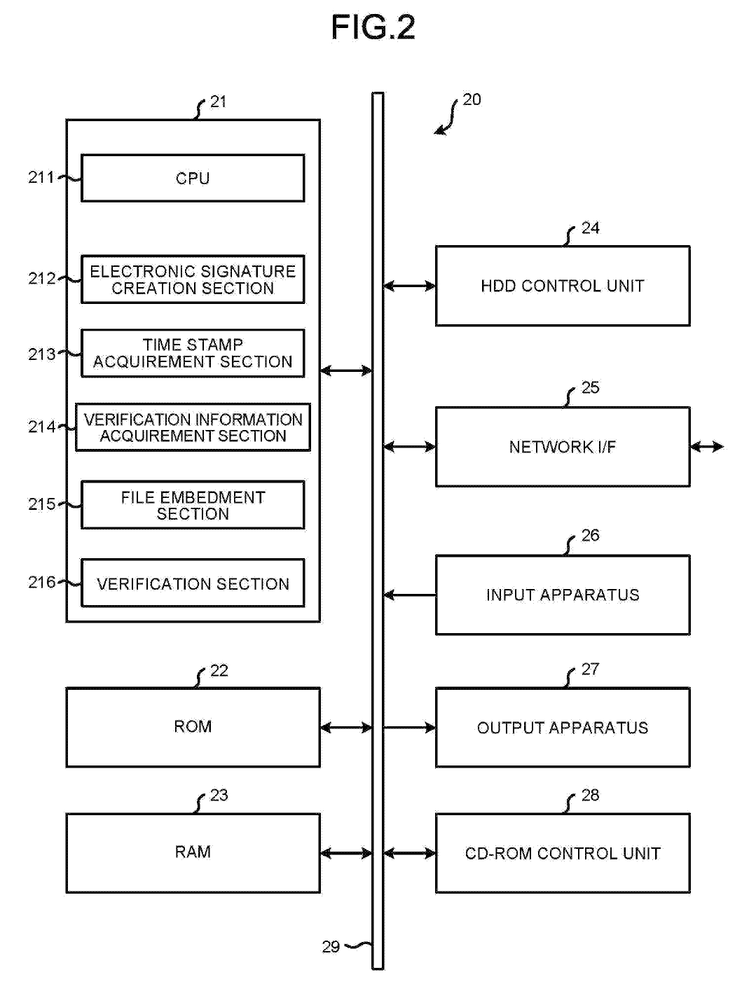

FIG. 2 is a block diagram illustrating a configuration of the document management server 20. As shown in FIG. 2, the document management server 20 comprises a control section 21 including a CPU 211 serving as a central processing unit, a ROM 22, a RAM 23, a HDD control unit 24, a network interface (I/F) 25, an input apparatus 26, an output apparatus 27, and a CD-ROM control unit 28. Each circuit unit described above is connected through a bus line 29.

The CPU 211 of the control section 21 controls overall processing of the document management server 20 according to a program stored in the ROM 22 and the like. In addition, the control section 21 includes an electronic signature creating section 212; a time stamp acquirement section 213 acquiring the time stamp issued from the time stamp authority 41; a verification information acquirement section 214 acquiring the verification information including the public key certificate from the certificate authorities 31, 32 . . . 3n; and a file embedment section 215 embedding the electronic signature, the time stamp, and the verification information in the electronic file. In addition, the control section 21 includes a verification section 216 verifying validity of the electronic file and the like by utilizing the verification information.

When calculation and processing of various data are carried out, the RAM 23 reads and writes the data. The HDD control unit 24 includes an HDD as a storage apparatus, and constitutes a file storage section storing various kinds of information (for example, the public key certificate acquired from the certificate authorities 31, 32, . . . , 3n, the revocation information, and time stamp information from the time stamp authority 41, and the like) and the like. The network I/F 25 is an apparatus connecting the document management server 20 with the network 100 and the LAN 15.

The input apparatus 26 includes an input device operated by the operator such as a keyboard, a mouse, and the like and creates an input signal by the operation of the operator. The output apparatus 27 is a display apparatus such as a liquid crystal display and the like, or a printing apparatus and the like. The CD-ROM control unit 28 includes a CD-ROM. A document management program or a verification program to be executed by the document management server 20 is stored in the CD-ROM, and moreover, the program stored in the CD-ROM is read out by the CD-ROM control unit 28. In addition, the control section 21 of the document management server 20 executes the program read out from the CD-ROM based on the control of the CPU 211.

Hereinafter, the processing of the document management apparatus according to the embodiment is described. In addition, in the following descriptions, the processing of the document management server 20, the certificate authority 31, and the time stamp authority 41 are described. The certificate authority (CA) and the time stamp authority (TSA) may include a plurality of authorities, and in that condition, the same processing is carried out. In addition, hereinafter, the time stamp authority is referred to as TSA.

First, as an advance preparation, a signer (the operator of the document management server 20) carrying out the electronic signature carries out an application of user registration to the trusted certificate authority 31, and acquires advance approval. In the application of the user registration, the key pair of a private key and a public key is created, and the public key is registered in the certificate authority 31. Thus, by asking the certificate authority 31 for the public key certificate, the public key certificate can be issued and acquired from the certificate authority 31.

Namely, when the document of the original is scanned by the scanner 12 of the MFP 10, image data (electronic document) acquired by the scanning is sent to the document management server 20. Herein, when the operator sends the electronic data such as the electronic document and the like through the network 100, the document management server 20 attaches the electronic signature of a sender (operator) and the public key certificate issued by the certificate authority to the electronic data. To create the electronic signature of the sender of the electronic data, the private key of the sender is used. The public key certificate is a certificate that the certificate authority 31 certifies and signs for the public key paired with the private key of the sender.

On the other hand, a receiver of the electronic data can confirm that the electronic data sent from the sender are not falsified and the electronic data are assuredly the electronic data sent from the sender himself by confirming the validity of the electronic signature and the public key certificate attached to the received data.

In addition, the public key certificate has an expiration date and is revoked and made invalid by the certificate authority issuing the public key certificate when the expiration date comes or if the private key is leaked or the encryption algorithm is broken before the expiration date. To confirm whether or not the public key certificate is revoked, the revocation list (CRL: Revocation List) of public key certificates issued by the certificate authority can be used. The ID, the revocation date, and the like of the revoked public key certificates among the public key certificates which are issued by the certificate authority and are before the expiration date are recorded in the CRL. Moreover, the CRL is accompanied by the signature of the certificate authority, and is periodically updated and issued by the certificate authority.

Therefore, whether or not the public key certificate is revoked can be determined by acquiring the CRL from the certificate authority 31 and confirming whether or not the ID of the attached public key certificate is recorded in the CRL. If the ID of the attached public key certificate is recorded in the CRL, the public key certificate is determined to be revoked. If the ID is not recorded in the CRL, the public key certificate is determined to be valid as long as the public key certificate is still before the expiration date.

In addition, for the signature to the public key certificate carried out by the certificate authority 31, the private key of the certificate authority 31 is used, and the public key paired with the private key of the certificate authority 31 is certified by other certificate authority. Therefore, the certificate authority 31 has a hierarchical structure. The certificate authority belonging the uppermost class is called as a root certificate authority, and issues the public key certificate certified by the root certificate authority itself.

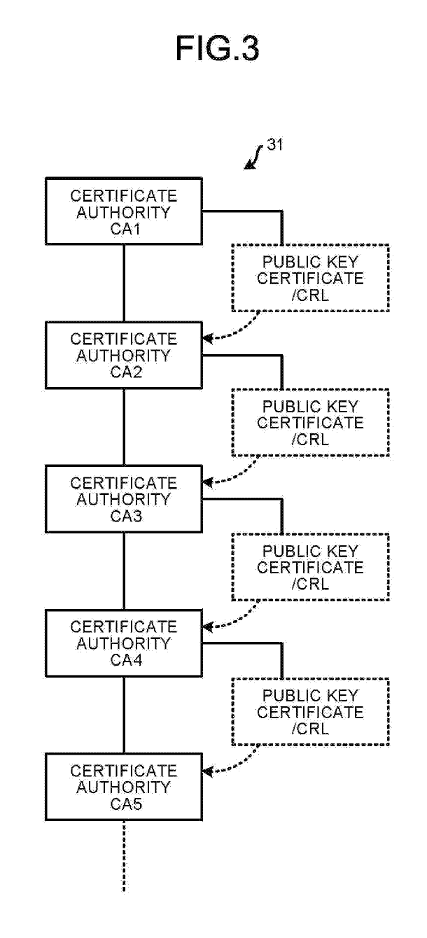

FIG. 3 is an illustration diagram illustrating the hierarchical structure of the certificate authority 31. In FIG. 3, the certificate authority 31 forms a group of the hierarchical structure in which a root certificate authority CA1 works as the uppermost class. For example, the certificate authority CA1 serving as the root certificate authority issues a public key certificate for a certificate authority CA2 at a lower layer. The certificate authority CA2 further issues a public key certificate for a certificate authority CA3 at the lower layer. Such issuance of the public key certificate is repeated until the certificate authority at a lowermost layer. Namely, that the public key certificate issued by the certificate authority at the lower layer is the correct public key certificate is certified by the certificate authority of the upper layer.

Therefore, the public key certificates issued by the certificate authority 31 are multiple and the file size of the CRL becomes large if too many revoked public key certificates exist. Therefore, for the receiver receiving the electronic data to which all CRL5 appearing in a path from the public key certificate of the signer to a root certificate are attached, the CRL with a size larger than the size of the data to be received may need to be included and stored, and therefore, the size of a disk that can be used for the data will be decreased.

In the first embodiment, the public key certificate that does not include the CRL is embedded in the PDF file, and the CRL can be acquired by referring to a URL (Uniform Resource Locator) described in a CRL distribution point included in the public key certificate. Using the URL, whether or not the public key certificate is revoked can be checked.

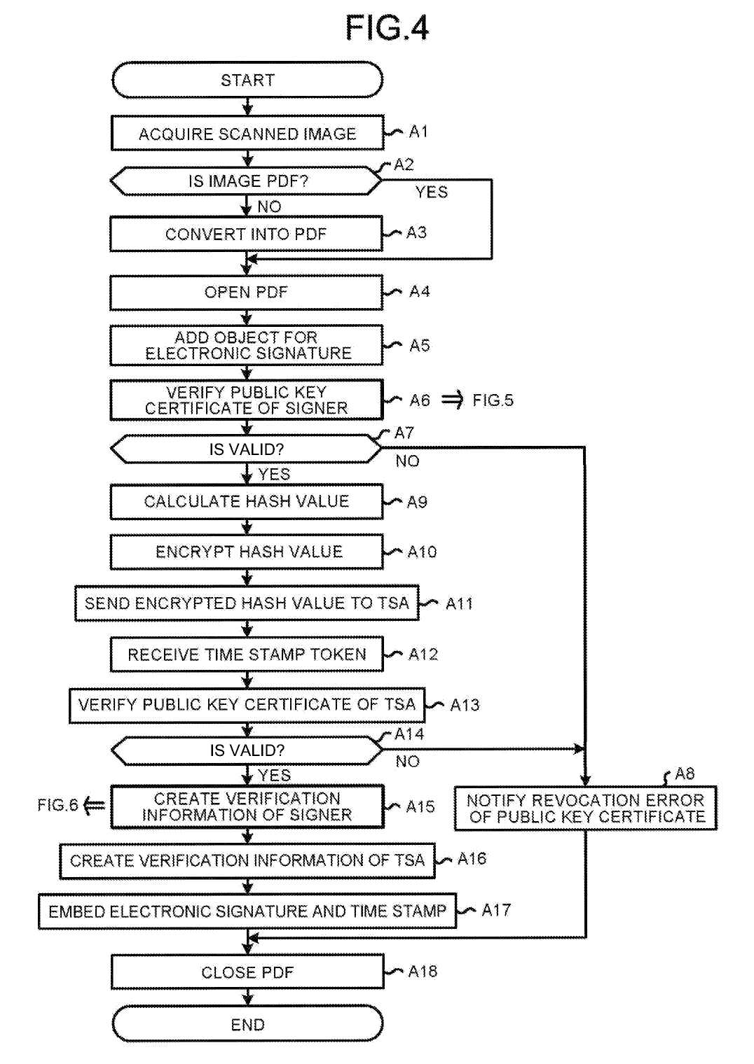

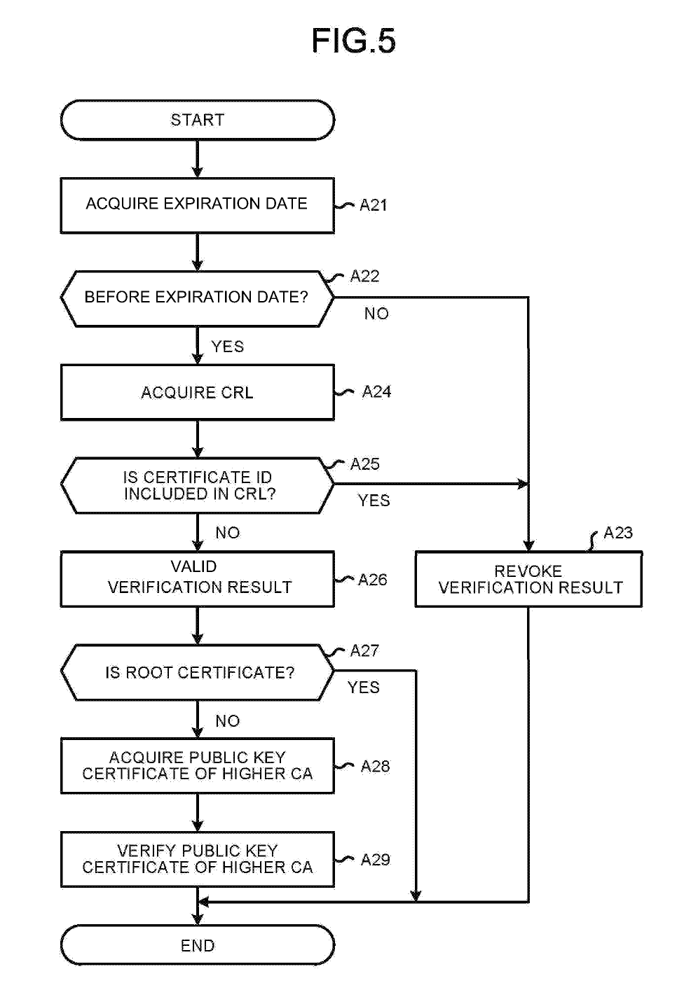

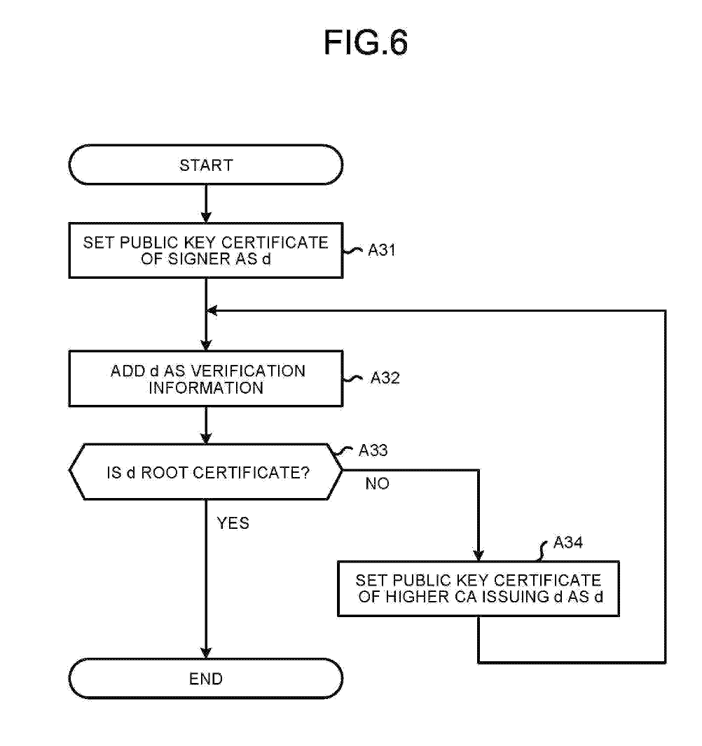

Next, the specific processing executed by the document management server 20 according to the first embodiment is described with reference to FIG. 4 to FIG. 6. FIG. 4 is a flowchart illustrating the processing of the document management server 20, FIG. 5 is a flowchart illustrating the verification processing of the public key certificate, and FIG. 6 is a flowchart illustrating the creating processing of the verification information. FIG. 4 to FIG. 6 mainly illustrate the processing of the electronic signature creating section 212, the time stamp acquirement section 213, the verification information acquirement section 214, and the file embedment section 215.

In ACT A1 of FIG. 4, the document management server 20 acquires image data corresponding to the image scanned by the scanner 12. In ACT A2, whether or not the acquired image data is in a form of a PDF file is determined. If the image data is not in a form of a PDF file but of a JPEG file or a TIEF file and the like, the image data is converted into a form of a PDF file in ACT A3, and then, the flow proceeds to ACT A4. If a plurality of image data exists, each of the image data is compiled into one PDF file. In addition, in ACT A2, if the acquired image data is in a form of a PDF file, the flow proceeds to ACT A4.

In ACT A4, the document management server 20 opens the PDF file, and creates the electronic signature for the PDF file. In ACT A5, the object of a PDF needed for the electronic signature is added to the PDF file to embed the data related to the electronic signature in the PDF file. Namely, when the data related to the electronic signature is embedded in the PDF file, what tag is attached has been predetermined, and therefore the embedment is carried out by using the predetermined tag. Next, in ACT A6, the public key certificate of the signer issued by the certificate authority 31 is verified. FIG. 5 is the flowchart illustrating a verification method of the public key certificate in ACT A6.

In FIG. 5, in ACT A21, the expiration date is acquired from the public key certificate. In ACT A22, whether or not the public key certificate has not expired is determined by comparing the acquired expiration date with a current date. If the public key certificate has already expired, the public key certificate has already been revoked and the flow proceeds to ACT A23 to end the verification processing of the public key certificate by determining the verification result to be “invalid”. If the public key certificate is still before the expiration date, the CRL is inquired and acquired from the certificate authority 31 issuing the public key certificate in ACT A24.

In a condition that the public key certificate is revoked due to some reason even though the public key certificate has not expired yet, a list of the IDs of the public key certificates issued by the certificate authority 31 is included in the acquired CRL. Therefore, in ACT A25, whether or not the ID of the public key certificate is included in the CRL is determined. If the ID of the public key certificate is included in the CRL, the public key certificate has been revoked and the flow proceeds to ACT A23 to end the verification processing of the public key certificate by determining the verification result to be “invalid”. If the ID of the public key certificate is not included in the CRL, the public key certificate is determined to be “valid” in ACT A26, and then, the flow proceeds to ACT A27.

In ACT A27, in order to confirm the correctness of the certificate authority 31 issuing the public key certificate, whether or not the public key certificate is the root certificate is determined. If the public key certificate is a certificate (root certificate) of the root certificate authority CA1, as the public key certificate is a self-signature certificate, the public key certificate is determined to be valid to end the verification. If the pubic key certificate is not the root certificate, as the certificate authorities belonging the upper classes issuing the public key certificate exist, the public key certificate of the certificate authority (CA) belonging to the upper classes is acquired using information related to the location of the certificate authority included in the public key certificate in ACT A28.

Afterwards, in ACT A29, the public key certificate of the certificate authority acquired in ACT A28 is verified. The verification processing will recursively execute the processing in FIG. 5. The verification processing is repeated until the public key certificate is finally determined to be the root certificate or the verification result is determined to be revoked.

In ACT A7 of FIG. 4, whether the verification result of the public key certificate of the signer is revoked or valid is determined. If the verification result is determined to be revoked, the flow proceeds to ACT A8 to notify an error indicating that the public key certificate is revoked, and then the PDF file is closed in ACT A18 to end the processing. If the verification result of the public key certificate of the signer is determined to be valid, the flow proceeds to ACT A9 to calculate a hash value for the signature object area of the PDF file. In ACT A10, the hash value acquired by calculation is encrypted by the private key corresponding to the public key certificate of the signer determined to be valid.

Next, in ACT A11, byte sequence data acquired by encrypting the hash value are sent to the TSA 41, and the issuance of the time stamp is requested. Then, in ACT A12, the TSA 41 issues a time stamp token including the time stamp and the signature of the TSA 41 based on the acquired data. In ACT A12, the time stamp token is received from the TSA 41. Next, in ACT A13, in order to verify the validity of the time stamp token, the public key certificate of the TSA 41 is acquired from the time stamp token, and the validity of the public key certificate of the TSA 41 is verified.

The verification processing of the public key certificate of the TSA 41 in ACT A13 is executed in accordance with the procedure based on the flowchart in FIG. 5. In ACT A14, whether or not the verification result of the public key certificate of the TSA 41 is revoked is determined. If the verification result is determined to be revoked, the flow proceeds to ACT A8 to notify an error indicating that the public key certificate of the TSA 41 is revoked, and then the PDF file is closed in ACT A18 to end the processing.

If the verification result of the public key certificate of the TSA 41 is determined to be valid, the verification information of the signer necessary for verifying the validity of the PDF file subsequently is created in ACT A15. Namely, in order to denote whether or not the PDF file is valid, the public key certificate is added herein. A method for creating the verification information of the signer in ACT A15 is illustrated in FIG. 6.

In FIG. 6, first, the public key certificate of the signer is set as d in ACT A31. Next, in ACT A32, the public key certificate d is added as the verification information. In ACT A33, whether or not the pubic key certificate d is the root certificate is determined, if the public key certificate d is the root certificate, the processing is ended, and if the public key certificate d is not the root certificate, the flow proceeds to ACT A34. In ACT A34, the public key certificate of the CA belonging the upper classes, which issues the pubic key certificate d, is set as a new d by using the public key certificate acquired in the process of the verification processing of the public key certificate of the signer in FIG. 5. Afterwards, the flow proceeds to ACT A32. The verification information of the signer is created in this way.

In ACT A16 of FIG. 4, the verification information of the public key certificate of the TSA is created. The processing may be carried out by replacing the “signer” with the “TSA” in the processing procedure (ACT A31) in FIG. 6.

Thus, as the data to be embedded in the PDF file are collected, the data including the verification information created by the processing procedure in FIG. 6 are embedded in the corresponding object in ACT A17, the PDF file is closed in ACT A18, and thus, the PDF file accompanied by the electronic signature and the time stamp is created.

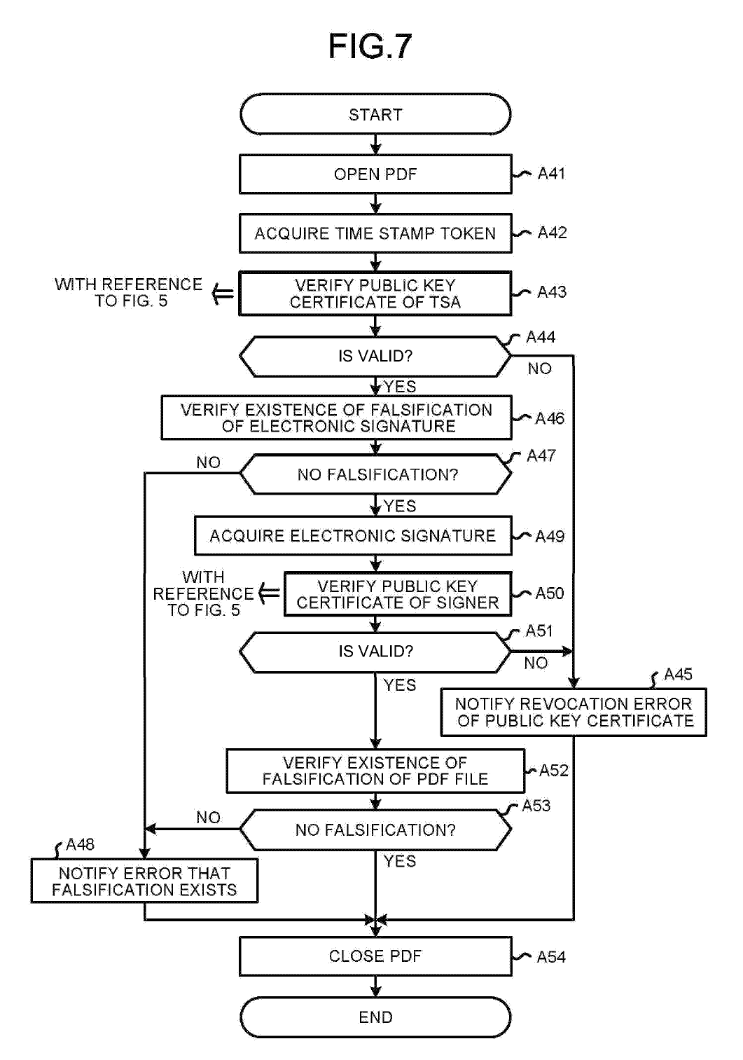

Next, a method for verifying the validity of the PDF file is described with reference to FIG. 7. FIG. 7 mainly illustrates the processing of the verification section 216.

In FIG. 7, in ACT A41, the PDF file serving as the object verifying the validity is opened. Next, in ACT A42, in order to verify the validity of electronic signature data of the TSA 41 embedded in the PDF file, the time stamp token is acquired from the PDF file. As the public key certificate of the TSA 41 issuing the public key certificate is included in the time stamp token, the public key certificate of the TSA 41 is verified by using the time stamp token in ACT A43.

A method for verifying the validity of the public key certificate is as illustrated in FIG. 5. With respect to specific verification processing in ACT A43, only the processing of “acquire CRL” in ACT A24 in FIG. 5 is different, and therefore, only this portion is described. Namely, the public key certificates including the root certificate can be acquired based on the verification information of the TSA 41 embedded in the PDF file, and therefore, the URL described in the CRL distribution point included in each public key certificate is accessed to acquire a newest CRL. Subsequently, the verification of the public key certificate of the TSA 41 is carried out based on the processing shown in FIG. 5.

Next, in ACT A44 in FIG. 7, a result is valid or revoked is determined based on the verifying result of the public key certificate of the TSA 41. If the public key certificate of the TSA 41 is determined to be revoked, the flow proceeds to ACT A45 to notify an error indicating that the public key certificate is revoked, and then the PDF file is closed in ACT A54 to end the processing. If the verifying result of the public key certificate of the TSA 41 is that the public key certificate of the TSA 41 is determined to be valid, whether or not the electronic signature portion is falsified is verified in ACT A46.

In ACT A46, a value is calculated by decrypting the data which are encrypted by the private key of the TSA 41, using the public key of the TSA 41. In ACT A47, the decrypted value and the hash value of the electronic signature are compared to determine whether or not there is a falsification. If the values are different, the electronic signature portion is falsified, thus, the flow proceeds to ACT A48 to notify an error indicating the falsification, and then the PDF file is closed in ACT A54 to end the processing. If the values which are compared in ACT A47 are the same, the electronic signature portion is not falsified, and thus, the electronic signature of the signer is acquired from the PDF file to verify the validity of the PDF file in ACT A49.

In ACT A50, the public key certificate of the signer included in the PDF file is verified. The method for verifying the validity of the public key certificate is carried out in accordance with the processing in FIG. 5. Here, with respect to the method for verifying the validity of the public key certificate, only the processing of the “acquire CRL” in ACT A24 in FIG. 5 is different, and therefore, only this portion is described. Namely, the public key certificates including the root certificate can be acquired from the verification information of the signer embedded in the PDF file, and therefore, the URL described in the CRL distribution point included in each public key certificate is accessed to acquire the newest CRL. Subsequently, the verification of the public key certificate of the signer is carried out according to the processing as recorded in FIG. 5.

Next, in ACT A51 in FIG. 7, whether the public key certificate of the signer is valid or revoked is determined based on the verifying result of the public key certificate of the signer. If the public key certificate of the signer is determined to be revoked, in ACT A45, the error indicating that the public key certificate is revoked is notified, and the PDF file is closed in ACT A54 to end the processing. If the verifying result of the public key certificate of the signer is that the public key certificate of the signer is valid, whether or not the signature object portion of the PDF file is falsified is verified in ACT A52.

In ACT A52, a value is calculated by decrypting the data encrypted by the private key of the TSA 41, using the public key of the TSA 41. In ACT A53, the decrypted value and the hash value of the signature object portion of the PDF file are compared. If the values are different, the PDF file is falsified, thus, the error indicating that the falsification exists is notified in ACT A48, and the PDF file is closed in ACT A54 to end the processing. If the values which are compared in ACT A53 are the same, the PDF file is not falsified, thus, the verification result of the PDF file is determined to be valid, and the PDF file is closed in ACT A54 to end the processing.

By carrying out such processing, the validity of the PDF file may be verified even if the CRL is not embedded in the PDF file.

Namely, this is because the public key certificate that does not include the CRL is embedded in the PDF file. The public key certificate is the public key certificate of all the certificate authorities appearing in the path from the public key certificate of the signer to the root certificate. Therefore, each public key certificate is verified and embedded, and subsequently, the newest CRL is acquired with reference to the URL described in the CRL distribution point included in each public key certificate when the public key certificate is verified, so that whether or not the public key certificate is revoked can be checked.

In addition, in the embodiment described above, the verification information of the signer and the verification information of the TSA are embedded in the PDF file during the creation of the PDF file, but a method for dynamically acquiring the verification information of the TSA during the verification without embedding the verification information of the TSA can be also considered.

In addition, in addition to a certificate chain from the public key certificate of the signer to the root certificate as the verification information of the signer, the CRL of the public key certificate may be also stored in the document management server 20 and time stamped so that the verification can be also carried out in an offline environment when the PDF file is verified. Hence, these URLs may be also added as the verification information of the signer. Thus, the CRL can be acquired from the verification information of the signer when the validity of the PDF file is verified, and therefore, the validity of each public key certificate can be checked.

### Second Embodiment

In a second embodiment, the CRL is stored in the document management server 20, and the URL leading to the corresponding CRL stored in the document management server 20 is embedded in the electronic file (PDF file).

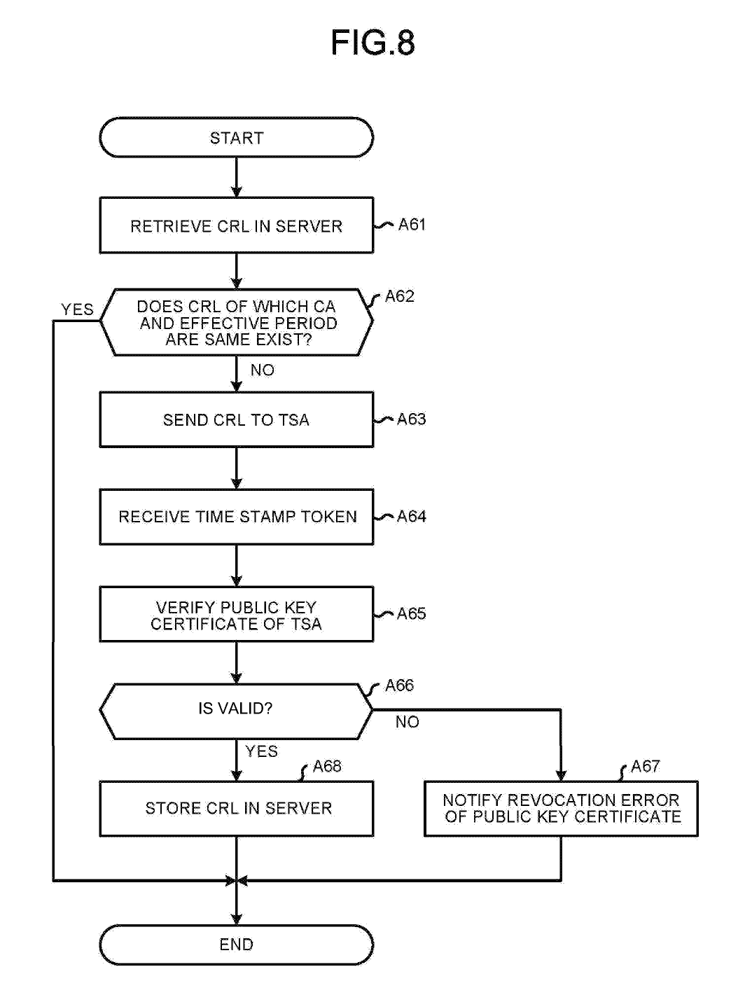

The processing of the second embodiment is carried out according to a flowchart in FIG. 8. In ACT A61 of FIG. 8, the CRL is acquired from the certificate authority 31, and whether or not the acquired CRL has been stored in the document management server 20 is searched. Searching conditions are the name of the certificate authority 31 distributing the CRL and the expiration date of the CRL. In ACT A62, the existence of the CRL of which the certificate authority name and the expiration date are the same is determined, if the same CRL is discovered, as the CRL does not need to be stored anew, the processing is ended, and if the same CRL is not discovered, the CRL needs to be stored anew. In addition, in order to prove that the CRL is not falsified and assuredly exists at the moment, in ACT A63, the CRL is sent to the TSA 41.

In ACT A64, the time stamp token is received by the TSA 41, and when the CRL to which time is stamped is received, in ACT A65, the public key certificate of the TSA 41 included in the time stamp token is verified. Afterwards, in ACT A66, the result of the verification of whether the public key certificate of the TSA 41 is revoked or valid is determined. If the result of the verification is that the public key certificate of the TSA is invalid, the error indicating that the public key certificate is revoked is notified in ACT A67 to end the processing. On the other hand, if the result of the verification is that the public key certificate of the TSA is valid, the CRL to which the time is stamped is stored in the document management server 20 in ACT A68 to end the processing.

In addition, when a plurality of documents is computerized, the same private key is used or the different private keys are used. If the certificate authority registering the key pair is the same, the CRL of the public key certificate is the same, and therefore, the CRL5 stored in the document management server 20 can be reduced into one, so as to save a storage area.

As described above, in the second embodiment, each CRL corresponding to each of the public key certificates issued by each of the certificate authorities appearing in the path from the public key certificate of the signer to the root certificate are acquired to be verified, and each of the CRL is stored in the document management server 20. However, the CRL5 are not embedded in the PDF file any more. Instead, each of the URLs leading to the corresponding CRL stored in the document management server 20 is embedded in the PDF file. During the verification of the public key certificate, whether or not the public key certificate is invalid is confirmed by accessing to the document management server 20 with reference to the URL embedded in the PDF file, so as to acquire the corresponding CRL.

In the second embodiment, the CRL can be integrally managed in the document management server 20, and compared with the condition that the CRL is embedded for each PDF file, the file size can be reduced. In addition, if the time stamp is given when the CRL is stored in the document management server 20, that the CRL exists at the moment can be also certified, so that it can be applied strictly.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A method for managing an electronic file, comprising:
creating an electronic signature of a user who is generating an electronic file by encrypting the electronic file using a private key of the user; and
embedding the created electronic signature of the user and a public key certificate of the user, in the electronic file,
the public key certificate of the user certifying a public key of the user corresponding to the private key of the user and including a link to a certificate list that shows whether or not the public key certificate of the user is valid.

2. The method according to claim 1, further comprising:
acquitting the certificate list from the certificate authority; and
storing the acquired certificate list.

3. The method according to claim 1, further comprising:
transmitting the embedded electronic file to a receiver of the electronic file.

4. The method according to claim 1, further comprising:
accessing the certificate list to check whether or not the public key certificate of the user is valid when the electronic file is opened.

5. The method according to claim 4, further comprising:
notifying a person who is opening the electronic file that the public key certificate of the user is not valid.

6. The method according to claim 1, further comprising:
acquiring from a time stamp authority a time stamp of the electronic file and a public key certificate of the time stamp authority, and
embedding the acquired time stamp of the electronic file and the acquired public key certificate of the time stamp authority, in the electronic file, wherein
the public key certificate of the time stamp authority certifies a public key of the time stamp authority corresponding to a private key of the time stamp authority and includes a link to a certificate list that shows whether or not the public key certificate of the time stamp authority is valid.

7. The method according to claim 6, further comprising:
accessing the certificate list of the public key certificate of the time stamp authority to check whether or not the public key certificate of the time stamp authority is valid when the electronic file is opened.

8. The method according to claim 7, further comprising:
notifying a person who is opening the electronic file that the public key certificate of the time stamp authority is not valid.

9. A method for managing an electronic file, comprising:
acquiring from a time stamp authority a time stamp of an electronic file and a public key certificate of the time stamp authority, and
embedding the acquired time stamp of the electronic file and the acquired public key certificate of the time stamp authority, in the electronic file, wherein
the public key certificate of the time stamp authority certifies a public key of the time stamp authority corresponding to a private key of the time stamp authority and includes a link to a certificate list that shows whether or not the public key certificate of the time stamp authority is valid.

10. The method according to claim 9, further comprising:
acquiring the certificate list from a certificate authority that has issued the public key certificate of the time stamp authority; and
storing the acquired certificate list.

11. The method according to claim 9, further comprising:
transmitting the embedded electronic file to a receiver of the electronic file.

12. The method according to claim 9, further comprising:
accessing the certificate list to check whether or not the public key certificate of the time stamp authority is valid when the electronic file is opened.

13. The method according to claim 12, further comprising:
notifying a person who is opening the electronic file that the public key certificate of the time stamp authority being not valid.

14. An electronic file management apparatus comprising:
a controller configured to:
create an electronic signature of a user who is generating an electronic file by encrypting the electronic file using a private key of the user; and
embed the created electronic signature of the user and a public key certificate of the user, in the electronic file,
the public key certificate of the user certifying a public key of the user corresponding to the private key of the user and including a link to a certificate list that shows whether or not the public key certificate of the user is valid.

15. The electronic file management apparatus according to claim 14, wherein
the controller is further configured to acquire the certificate list from the certificate authority, and the apparatus further comprising:
a storage configured to store the certificate list acquired by the controller.

16. The electronic file management apparatus according to claim 14, further comprising:
a network interface through which the electronic file in which the electronic signature of the user and the public key certificate of the user are embedded is transmitted to a receiver of the electronic file.

17. The electronic file management apparatus according to claim 14, wherein
the controller is further configured to access the certificate to check whether or not the public key certificate of the user is valid when the electronic file is opened.

18. The electronic file management apparatus according to claim 17, wherein
the controller is further configured to notify a person who is opening the electronic file that the public key certificate of the user is valid.

19. The electronic file management apparatus according to claim 14, wherein the controller is further configured to
acquire from a time stamp authority a time stamp of the electronic file and a public key certificate of the time stamp authority, and
embed the acquired time stamp of the electronic file and the acquired public key certificate of the time stamp authority, in the electronic file, wherein
the public key certificate of the time stamp authority certifies a public key of the time stamp authority corresponding to a private key of the time stamp authority and includes a link to a certificate list that shows whether or not the public key certificate of the time stamp authority is valid.

20. The electronic file management apparatus according to claim 19, wherein
the controller is further configured to access the certificate list of the public key certificate of the time stamp authority to check whether or not the public key certificate of the time stamp authority is valid when the electronic file is opened.
